(19) United States
(12) Patent Application Publication
(10) Pub. No.: US 2014/0300449 A1
(43) Pub. Date: Oct. 9, 2014

(54) TAXI HAILING SYSTEM AND MOBILE APPLICATION

(71) Applicant: Ani Kounavis, New York, NY (US)

(72) Inventor: Ani Kounavis, New York, NY (US)

(21) Appl. No.: 14/247,007

(22) Filed: Apr. 7, 2014

Related U.S. Application Data
(60) Provisional application No. 61/809,140, filed on Apr. 5, 2013.

(51) Int. Cl. G08B 7/06

(52) U.S. Cl. CPC G08B 7/06
USPC 340/6.1

(57) ABSTRACT

A system and method for taxi hailing may include providing a prompt to initiate hailing of a taxi. A start command may be received. A visual indicator and an audio indicator may be provided on a display device. A prompt for a hailing stoppage may be provided. A stop command may be received. The visual indicator and the audio indicator may stop. The method may be used in order to hail a taxi from a safe distance from the street while distinguishing the user from other pedestrians.

### CROSS-REFERENCE TO RELATED APPLICATION

This application claims the benefit of U.S. provisional application No. 61/809,140, filed Apr. 5, 2013, the contents of which are herein incorporated by reference.

### BACKGROUND OF THE INVENTION

The present invention relates to hailing taxis and, more particularly, to a taxi hailing system, method and mobile application.

With the growing population and increased tourism it is a challenge to hail one of the limited numbers of taxis available, especially in the evening. The current manual method of hailing a taxi requires standing close to or on the road, in order to try and gesture for attention. This process is not effective and it is not safe. This is especially true at night when patrons are not seen as easily.

As can be seen, there is a need for a taxi hailing system, method and mobile application that allows for audio and visual indicators.

### SUMMARY OF THE INVENTION

In one aspect of the present invention, a method for taxi hailing comprises: providing a prompt to initiate hailing of a taxi; receiving a start command; providing a visual indicator and an audio indicator on a display device; providing a prompt for a hailing stoppage; receiving a stop command; and stopping the visual indicator and the audio indicator.

In another aspect of the present invention, a system for taxi hailing comprises: a computer having a user interface; a program product comprising machine-readable program code for causing, when executed, the computer to perform the following process steps: providing a prompt to initiate hailing of a taxi; receiving a start command; providing a visual indicator and an audio indicator on a display device; providing a prompt for a hailing stoppage; receiving a stop command; and stopping the visual indicator and the audio indicator.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a front view of an exemplary embodiment of the present invention in a start mode;

FIG. 3 is a front view of an exemplary embodiment of the present invention in an activated mode;

FIG. 4 is a front view of an exemplary embodiment of the present invention in a settings screen;

FIG. 5 is a schematic view of an exemplary embodiment of the present invention application operation; and

FIG. 6 is a schematic view of exemplary embodiment of the present invention settings screen operation.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method for taxi hailing that may include providing a prompt to initiate hailing of a taxi. A start command may be received. A visual indicator and an audio indicator may be provided on a display device. A prompt for a hailing stoppage may be provided. A stop command may be received. The visual indicator and the audio indicator may stop. The method may be used in order to hail a taxi from a safe distance from the street while distinguishing the user from other pedestrians.

The present invention may include at least one computer with a user interface. The computer may include any computer including, but not limited to, a laptop, a laptop/tablet combination, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may clearly display the need for a taxi. The mobile device application may allow for a flashing light and sounds such as whistling to identify the user's intent for a taxi, while handling the process safely. The mobile device application may also distinguish the user from other people such as other pedestrians on the street in a busy city, thereby increasing the changes of hailing a taxi effectively.

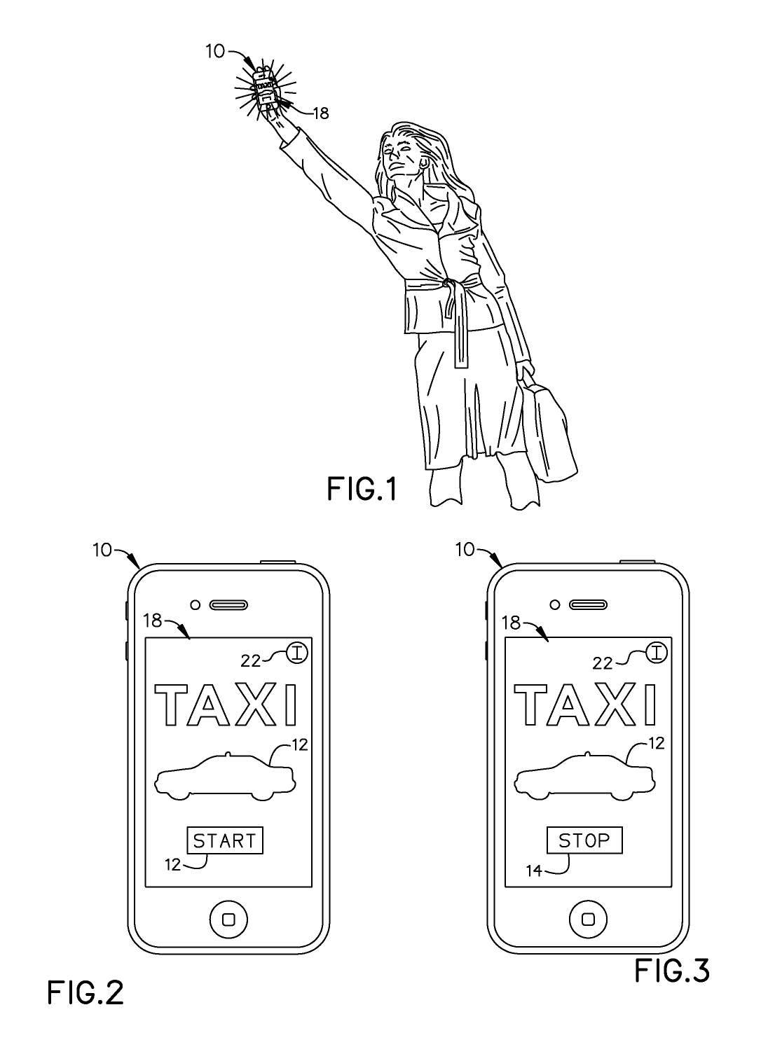

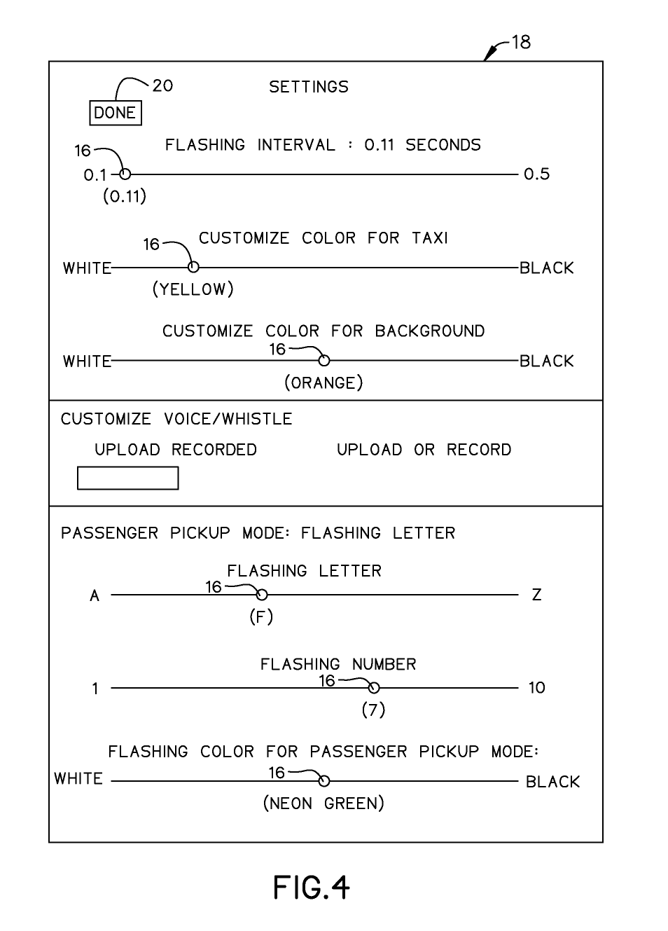

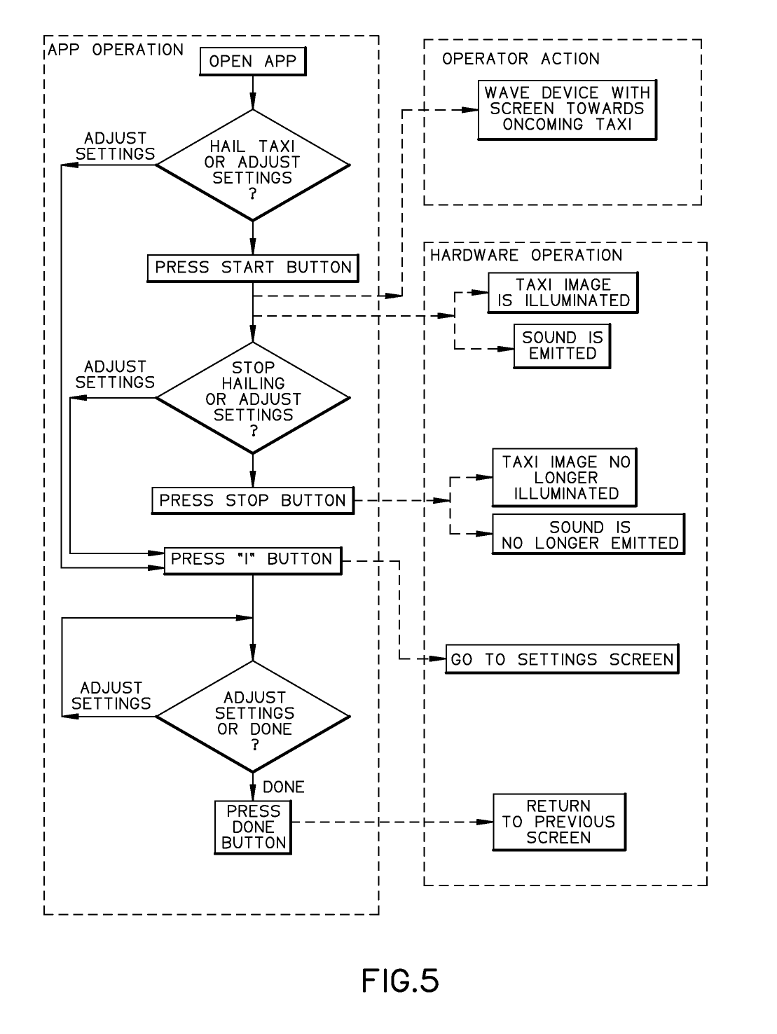

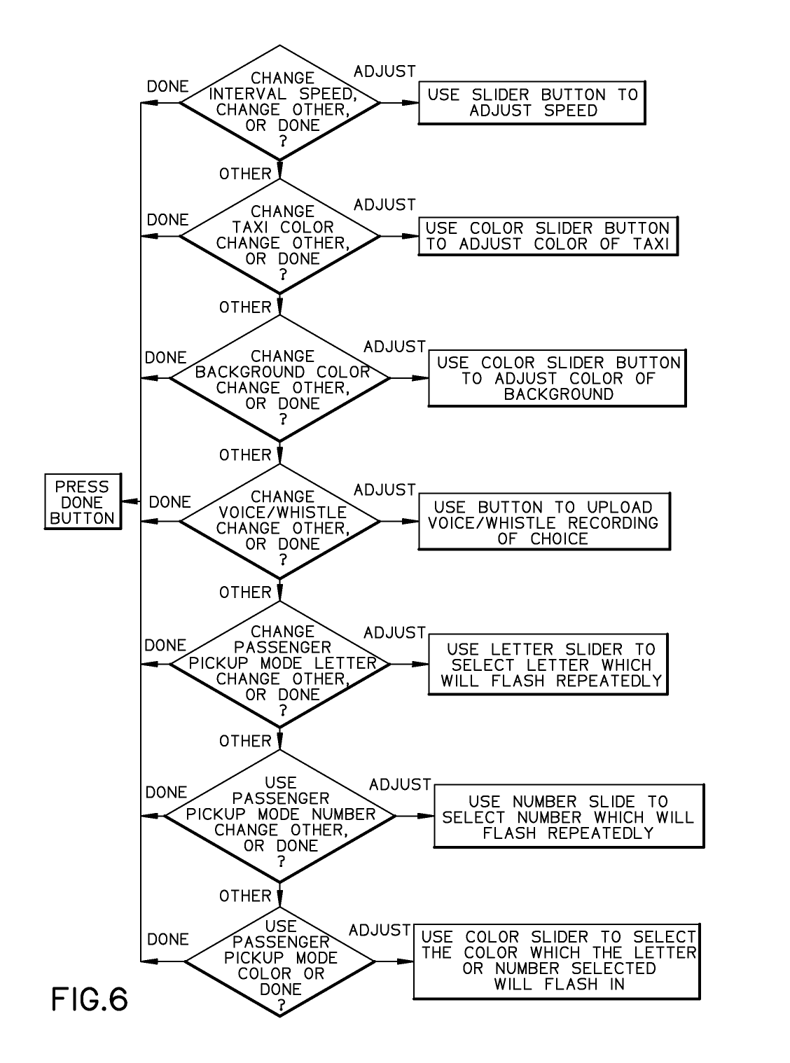

As is illustrated in FIGS. 1 through 6, a taxi hailing system may include a display device 10. The display device 10 may be a mobile device such as a smart phone, tablet or the like. The display device 10 may have a display 18 showing an application. When a user may want to use the application, the user may view a prompt to initiate hailing a taxi. The display 18 may show a start button 12. The user may press the start button 12 in order to initiate the process. In certain embodiments, when the start button 12 may be pressed, the display 18 on the display device 10 may have a visual indicator that a taxi is being requested. The visual indicator may include a background color and a foreground image of a taxi or the like. The image may flash a certain number of intervals. In certain embodiments, the color of the background and the taxi may switch with each flash to further indicate the request for the taxi. In certain embodiments, when the start button 12 may be pressed, the application may also produce an audio indicator that the taxi is being requested. The audio indicator may be a whistle or the like, and may be a customized recording. The volume of the audio indicator may be adjusted by the display device 10 volume adjustments. The display 18 may show a prompt for a hailing stoppage. When the user may be ready to stop the application, the user may press the stop button 14 on the display 18. The visual indicator and the audio indicator may stop at this point in time.

In certain embodiments, an icon may be displayed as a settings button 22. The settings button 22 may bring up another display on a screen of the display device 10. Various settings may be displayed on a settings display 18, including, but not limited to, interval speed, foreground image color, background color, voice, passenger pickup mode: letter change, number change, and color change. Changes of settings may be applied by sliding a slider 16 placed under the specific setting to be updated. Once settings changes have been completed, the user may press an icon on the display 18 that may designate completion such as done 20 or the like.

The passenger pickup mode may be a feature which may allow the user to display a visual indicator that is a unique identifier on the display device 10, such as at a time of a pre-arranged pickup. The passenger pickup mode may allow the driver who is picking up the user, to see the user more easily. In the case where multiple people are waiting at the same intersection, the unique identifier may distinguish the user who arranged for the pickup. The user may select from any ‘letter’, ‘number’, ‘symbol’, ‘color’, or combination of these, to identify themselves as the person who arranged the pick-up. In this situation, the unique identifier may be different from the taxi symbol. The user may use this option in situations where there may be a pre-arranged taxi pick-up, limo, shared ride scenarios, or the like. The user may have been informed of the driver's car make and model, driver name or license number, however, there is no method for the driver to easily recognize the user/client. Using the Passenger Pick Up mode, the user and the driver may select a unique identifier in advance such as the letter, number, color, or combination.

A method of using the passenger pickup mode may include the following. The user may arrange a pick up from a taxi or limo at the corner of 44th Street and Lexington Ave or some other location. The user/client may have the information on the driver's description, car make and model, and license number. Usually, the driver may not have information about the user/client other than their name. During the pre-arranged pick-up, the user may indicate they will hold up a RED COLORED FLASHING A on their mobile device. As the driver pulls up to the intersection, the driver may now easily identify the user because of the pre-arranged identifier. The driver may look for the user/client displaying the red colored FLASHING A on their device. In certain embodiments, the identifier may be a flashing number, such as a FLASHING 7 or the like. The user/client may also select a unique color and use it in combination with the letter or number, or both such as with a FLASHING BLUE A7. Using the color feature may help distinguish the client even further. In busy cities and at more popular pick up locations such as airports, the combinations of letters, numbers and colors may be an efficient method to reduce confusion from any two clients who made pre-arranged pick-ups at the same time.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for taxi hailing comprising:
providing a prompt to initiate hailing of a taxi;
receiving a start command;
providing a visual indicator and an audio indicator on a display device;
providing a prompt for a hailing stoppage;
receiving a stop command; and
stopping the visual indicator and the audio indicator.

2. The method for taxi hailing of claim 1, further comprising a step providing a prompt for adjustment of settings.

3. The method for taxi hailing of claim 2, further comprising a step receiving an adjustment command.

4. The method for taxi hailing of claim 1, wherein the visual indicator is a flashing image alternating colors of a background color and foreground image.

5. The method for taxi hailing of claim 4, wherein the foreground image is the shape of a taxi.

6. The method of taxi hailing of claim 1, wherein the visual indicator is a unique identifier, wherein the unique identifier is selected from the group consisting of letters, numbers, symbols, colors, and mixtures thereof.

7. A system for taxi hailing comprising:
a computer having a user interface;
a program product comprising machine-readable program code for causing, when executed, the computer to perform the following process steps:
providing a prompt to initiate hailing of a taxi;
receiving a start command;
providing a visual indicator and an audio indicator on a display device;
providing a prompt for a hailing stoppage;
receiving a stop command; and
stopping the visual indicator and the audio indicator.

8. The system for taxi hailing of claim 6, further comprising a step providing a prompt for adjustment of settings.

9. The system for taxi hailing of claim 7, further comprising a step receiving an adjustment command.

10. The system for taxi hailing of claim 6, wherein the visual indicator is a flashing image alternating colors of a background color and foreground image.

11. The system for taxi hailing of claim 9, wherein the foreground image is the shape of a taxi.

12. The system for taxi hailing of claim 7, wherein the visual indicator is a unique identifier, wherein the unique identifier is selected from the group consisting of letters, numbers, symbols, colors, and mixtures thereof.
